(19) United States
(12) Patent Application Publication
(10) Pub. No.: US 2008/0219025 A1
(43) Pub. Date: Sep. 11, 2008

(54) Bi-directional backlight assembly

(76) Inventors: Mark B. Spitzer, Sharon, MA (US); Noa M. Rensing, Newton, MA (US); Maureen A. Lincoln, Norton, MA (US); Arash Haghayegh, Quincy, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/715,289

(22) Filed: Mar. 7, 2007

(51) Int. Cl. F21V 7/04

(52) U.S. Cl. 362/609; 362/611; 362/612; 362/614

(57) ABSTRACT

A backlight assembly emits light out of two light emitting faces using a light source such as side-emitting LEDs that send light into an optical guide or body of optical material that diffuses the light uniformly and emits bi-facially. In this way, two displays, such as LCDs, can be illuminated at the same time and the efficiency is increased. The backlight assembly can be incorporated into an eyewear system such as a binocular display system.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The development of binocular portable electronic displays in the form of eyewear is of great interest for viewing portable video content. In order for such devices to gain popularity in the consumer market, the mass and size of the systems must be very low. Preferably the mass is similar to modern eyewear in the range of 25 grams to 75 grams, and the volume is sufficiently low that the device approaches the look and feel of eyewear. Recently, Spitzer et al. (U.S. Pat. No. 6,879,443) described a binocular viewing device in which two LCDs and two LED backlights could be used in such a device. FIG. 1 illustrates the prior art design shown in U.S. Pat. No. 6,879,443. A nose bridging element 50 joins two backlights 40 and two liquid crystal displays 30. The displays 30 are in optical communication with an optical pipe 21 that relays light to mirrors 59 and then to the eyes through left and right eye lenses 60.

A prior art flat backlight, for example the backlight of U.S. Pat. No. 6,496,237 B1 (FIG. 12) uses LEDs to inject light into a cavity. Various methods are used to diffuse the light and spread it uniformly within the cavity, including the use of diffusely reflective surfaces. Light is extracted from one aperture only and is intended to illuminate one display only. Methods are also known in the art of injecting light from LEDs into waveguide cavities (U.S. Pat. No. 6,134,092) and LEDs have been designed for this purpose (EP 1 746 666 A2). However, in these approaches, light is intended to exit only through a front aperture and therefore the interior back surface is optimized for high reflectance. In this way photons that are propagating to the back surface (i.e. the wrong direction) are backscattered and redirected toward the front aperture and therefore have an opportunity to be emitted through the front aperture. In general, the interior back surface will not be a perfect reflector and/or scattering surface and therefore will absorb some photons. Additionally, the back interior surface will scatter some fraction of incident photons into angles that will not result in a trajectory that makes possible transmission through the front aperture. These photons will be scattered or absorbed at various interior surfaces within the cavity or waveguide, or will eventually be emitted through the front aperture.

### SUMMARY OF THE INVENTION

A backlight assembly is provided that emits light bi-facially or bi-directionally to illuminate two displays. The backlight assembly provides a reduction in mass and volume and increases efficiency.

In one embodiment, the backlight assembly includes a circuit substrate comprising a first surface defining a first side and a second surface defining a second side. An opening is formed through the circuit substrate from the first side to the second side. A body of optical material is disposed within the opening in the circuit substrate. The body of optical material comprises an edge disposed within the opening in the circuit substrate, a first light emitting face located on the first side of the circuit substrate, and a second light emitting face located on the second side of the circuit substrate. A light source, such as side-emitting LEDs, is disposed to direct light into a location along the edge of the optical material body. The light source is in communication with circuitry on the circuit substrate. First and second displays, such as two LCDs, receive light emitted from the light emitting faces of the backlight assembly. The backlight assembly and associated displays can be incorporated into an eyewear system such as a binocular viewing device or display system.

The backlight assembly is advantageous because the mass can be lowered by using one backlight assembly to illuminate both LCDs. Also, the LCDs can be moved closer together to increase the distance between the eye lens and the display. Increasing this distance makes possible a greater range of LCD positions and increases the designer's freedom to match magnification, LCD size, and virtual image size to user preferences. The greatest distance is obtained when one backlight assembly, emitting in both the left and right directions, is placed at the center between the two LCDs. Thus, by forming one integrated backlight assembly, the distance between the LCDs is minimized, and the mass of the illumination system is minimized.

Also, the backlight assembly utilizes light that would have undergone multiple interior scattering events and increased optical absorption in the prior art backlight systems. Therefore, the backlight assembly results in reduced optical absorption and improved efficiency.

### DESCRIPTION OF THE DRAWINGS

The invention will be more fully understood by reference to the following detailed description of the invention in conjunction with the drawings, of which:

FIG. 1 is a schematic illustration of a prior art binocular viewer;

FIG. 2 is a schematic illustration of a binocular viewer incorporating a backlight assembly according to the present invention;

FIG. 3 is a schematic isometric view of a bi-directional backlight assembly according to the present invention;

FIG. 4 is a schematic plan view of a further bi-directional backlight assembly;

FIG. 5 is a schematic cross sectional side view of a further backlight assembly;

FIG. 6 is a schematic illustration of a backlight using an angled laminar reflector stack;

FIG. 7 is a schematic side view of a further backlight assembly illustrating an optical body formed by casting;

FIG. 8 is a schematic side view of a further backlight assembly using one display and a reflective surface;

FIG. 9 is a schematic side view of a further backlight assembly illustrating LEDs on both sides of a circuit board and optical films within the optical material body;

FIG. 10 is a schematic top view of a bi-directional backlight assembly in a binocular viewer;

FIG. 11 is a schematic illustration of a backlight using reflective surfaces to capture additional emissions from the LEDs;

FIG. 12 is a schematic illustration of a backlight using top emitting LEDs;

FIG. 13 is a schematic top view of the binocular viewer of FIG. 10 illustrating reduction in a convergence distance and focal length;

FIG. 14 is a schematic front view of a bi-directional backlight assembly in a frame or housing of a binocular viewer;

FIG. 15 is a schematic side view of a backlight assembly illustrating a taper;

FIG. 16 is a schematic top view of a binocular viewer illustrating face curvature created by tilting optics with respect to a vertical axis and/or tapering the backlight assembly;

FIG. 17 is a schematic front view of a binocular viewer illustrating face curvature created by tapering the backlight assembly;

FIG. 18 is a schematic view of the optics of FIG. 17 illustrating correction for rotation of the image; and

FIG. 19 is a schematic side view of a further backlight assembly using a shaped diffuser or reflective element.

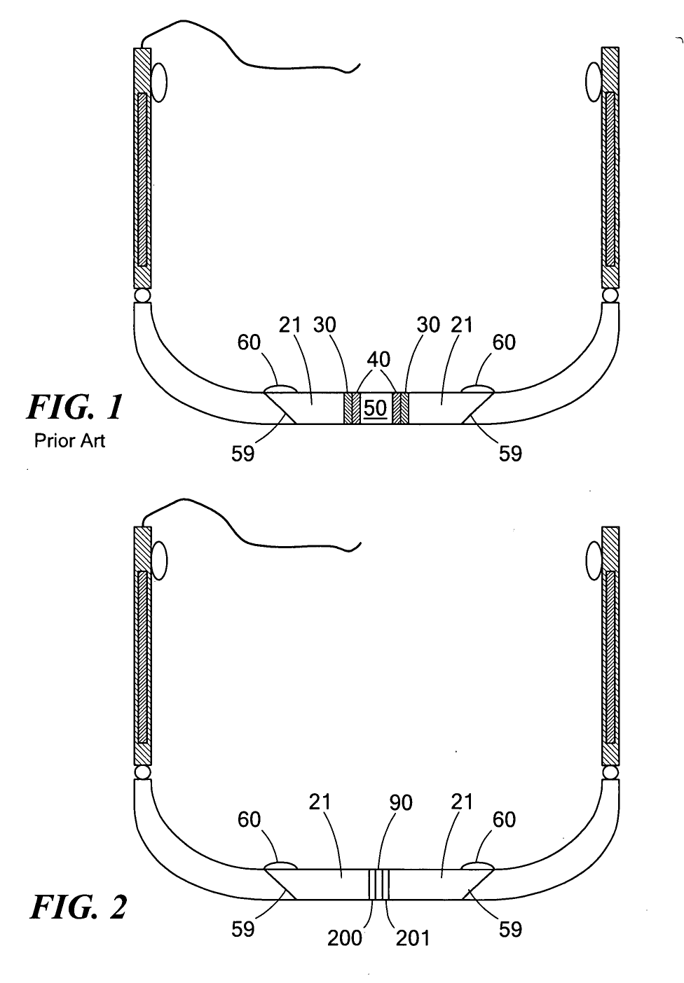

### DETAILED DESCRIPTION OF THE INVENTION

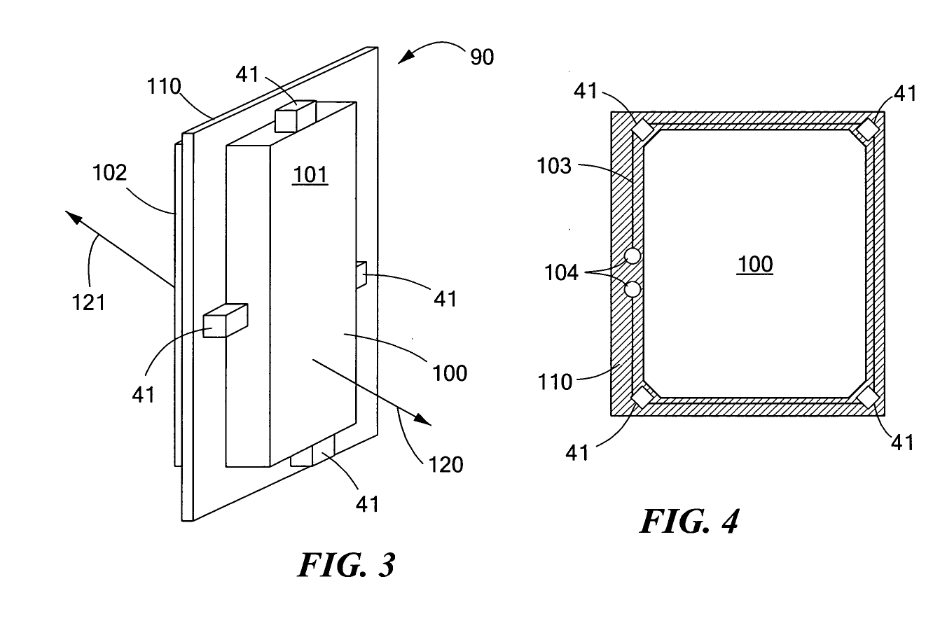

An embodiment of a bi-directional backlight assembly 90 capable of illuminating two displays, such as LCDs 200, 201, is shown in FIGS. 2 and 3. FIG. 2 illustrates the backlight assembly in use in a binocular viewing device. The displays 200, 201 are in optical communication with an optical pipe 21 that relays light to mirrors 59 and then to the eyes through left and right eye lenses 60. The backlight assembly comprises an optical guide or body 100 of optical material such as optical polymethylmethacrylate (PMMA), polycarbonate, glass, urethane, optical epoxy, or similar optical material. Many other suitable candidates are known in the art. The exact specification of the optical material is not important to the invention. Preferably it has an index of refraction of between 1.4 and 1.8, is low in absorption, and can be formed by one or more conventional optical processes such as grinding and polishing, casting, extrusion, or injection molding, into a membrane having a thickness of between 1 and 5 mm. The optical material body 100 has left and right emitting faces 101 and 102 that may be flat, curved, or otherwise shaped for a specific light emission pattern required by the optical design. The surfaces may furthermore be textured or coated to achieve specific desirable optical properties. The optical material body 100 may be affixed to a circuit substrate such as a printed circuit board 110 which is itself in electrical contact with a light source such as edge-emitting light emitting diodes (LEDs) 41. The optical material body 100 may extend to the edges of the circuit board 110 and fully encapsulate the LEDs. It is desirable that the optical material be physically coupled to the LEDs to remove air gaps, so as to increase the amount of light delivered from the LEDs to the backlight by removing reflections that would occur at air interfaces.

To allow the thickness of the backlight to be reduced and to allow the weight to be reduced, the printed circuit board may be replaced by a thin flexible circuit substrate such as is known in the art (for example, a flex-circuit fabricated from Kapton). In this case, the body of optical material 100 may also provide the necessary mechanical rigidity as well as serving to mechanically secure the backlight within the display assembly.

A light source is provided, such as a number of side-emitting packaged LEDs 41 placed at edges of the optical material body; these LEDs emit rays into the volume of the optical material 100. Suitable LEDs are, for example, Nichia white LED part number NESW008. The quantity of LEDs 41 and the placement of LEDs 41 may be selected for attainment of uniformity of the brightness of faces 101 and 102. For example, four LEDs 41 may be placed at the four corners of optical material 100, as shown in FIG. 4. The LEDS may be mounted on a printed circuit board 110 with electrical traces 103 for providing current to the LEDs. Electrical connection may be made through pads 104. Alternatively, uniformity of light emission may be achieved by specifying different LEDs at different locations on circuit board 110. While FIG. 4 indicates a simple series circuit in which the current flowing through each LED is equal, alternative circuits are possible in which the current and hence the light output of each LED differ, in order to compensate for spatial or other non-uniformity, the end result being a uniform emission of light by the backlight assembly. For example, each LED may be placed in series with a resistor, and tie LED and resistor pairs may be interconnected in parallel. The resistors are then selected to adjust the light output of each LED to obtain the desired emission uniformity.

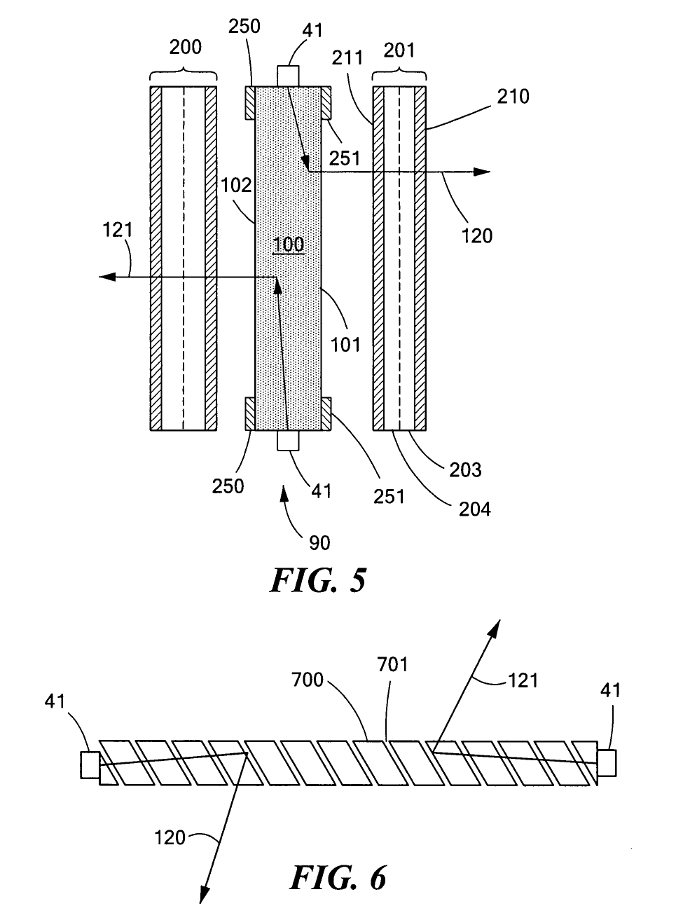

The optical material 100 preferably contains scattering centers which cause the rays emitted by the LEDS to be scattered one or more times until they reach either the left 102 or right 101 face (FIGS. 3, 5). Upon reaching the faces the rays are emitted in two generally opposite directions, as shown representatively by rays 120 and 121. The actual range of angles represented by rays 120 and 121 is dependent on the construction of the backlight assembly, and for many designs the radiation may be Lambertian in nature. Optical diffusers or other optical sheets such as brightness enhancing films may be placed on the emitting surfaces to affect the distribution of light emitted from the surface. Methods known in the art may be used to minimize the area of printed circuit board 110 so as to attain a compact form factor.

A preferred embodiment uses side-emitting surface-mount LEDs which are provided with internal optical elements within the surface mount package to direct photons in a preferred direction. However, any other type of LED or even unpackaged LED dice may be used, provided that a sufficient density of photons is directed into the optical material 100 by reflectors and other devices known in the art. Additionally, any combination of LEDs with differing emission spectra may be used to create the desired backlight emission spectra. For use with field sequential LCDs, the backlight may be constructed from red, green and blue LEDs that are independently powered.

FIG. 5 shows in a cross sectional view that two LCDs 200 and 201 can be mounted in proximity to the backlight which illuminates the LCDs in a manner well known in the art of LCD lighting. LEDS 41 emit light rays generally indicated by rays 120, 121 which are scattered by optical material 100. Ray 120 is shown in FIG. 5 to propagate out of the backlight assembly and into and then through polarizer 211 and then through the first and second layers of glass 204, 203 of LCD 201, and finally out through the analyzing polarizer 210 of LCD 201. Rays, illustrated by ray 121, undergo similar propagation through LCD 200. A mask 250, 251 may be placed on each side of the body 100 of the backlight assembly to prevent light from striking sensitive areas of the LCD such as drive circuits that are outside the active matrix pixel area. Alternatively, the masks 250, 251 may be placed directly on the LCDs. The LCDs may be aligned to each other using techniques known in the art. The resulting assembly can be placed into a binocular viewing device such as the device in FIG. 2 for mounting on the head.

The light pattern emitted from the front and back face of the display will have angular and spatial distributions that depend on the LED emission pattern and the index of refraction of the internal material used to fill the packages housing LEDs 41 as well as the index of refraction of optical material 100. Scattering centers may be added to optical material 100 to adjust the uniformity or other characteristics of the emission. The scattering centers may be reflecting or refracting elements, and the distribution within the volume of optical material 100 may be random, uniform, or may vary according to a preferred distribution profile. In one preferred embodiment of the backlight assembly, the scattering centers are air filled glass bubbles (such as 3M Scotchlite). Owing to the large index of refraction change at the interface between optical material 100 and a glass bubble interior, and to the high curvature of the interface, the bubbles introduce a large amount of scattering with nearly zero absorption. Alternative scattering centers may be created by introducing air or other gas bubbles through other methods, or by using particles of a different index of refraction than the optical material 100. Another alternative is to use white or metallic scattering particles.

In another embodiment, optically active material may be used to control the emission pattern from the backlight. For example, light emitting phosphors may be either dispersed through the bulk of the material 100 or coated on the surface of the optical material 100 to emit light at the appropriate location. Blue edge emitting LEDs may be used to excite volumetrically dispersed yellow phosphor to emit white light. Alternatively, an LED emitting ultraviolet radiation may be used to illuminate a combination of one or more phosphors to create white light.

In another embodiment, the light traveling within the body may be coupled out of the backlight assembly using laminar reflectors as shown in FIG. 6. The reflectors may be, for example, of a stack of optically clear plates 700 interspersed with partially reflective dielectric coatings. Alternatively the plate surfaces may be textured to provide scattering out of the backlight assembly. In another alternative embodiment, the plates may be separated by plates or films of a different index of refraction or by air gaps 701 to partially reflect the light traveling transversely through the backlight assembly. The spacing and angle of the laminar reflectors are chosen to maximize the spatial uniformity of the backlight assembly and/or to control the angular distribution of the emitted light. Stacks of plates may be fabricated by any convenient method known to the art and the stack may then be shaped into the desired shaped spacer in a secondary operation using conventional machining methods.

As shown in FIG. 19, another method for achieving a uniform spatial distribution of the light is to place a shaped diffuser or reflective element 141 within the volume of the optical material body 100. This element may have a prismatic or curved structure designed to control the light emission pattern and may be made in any manner known in the art, including embossing, injection molding, casting, or engraving.

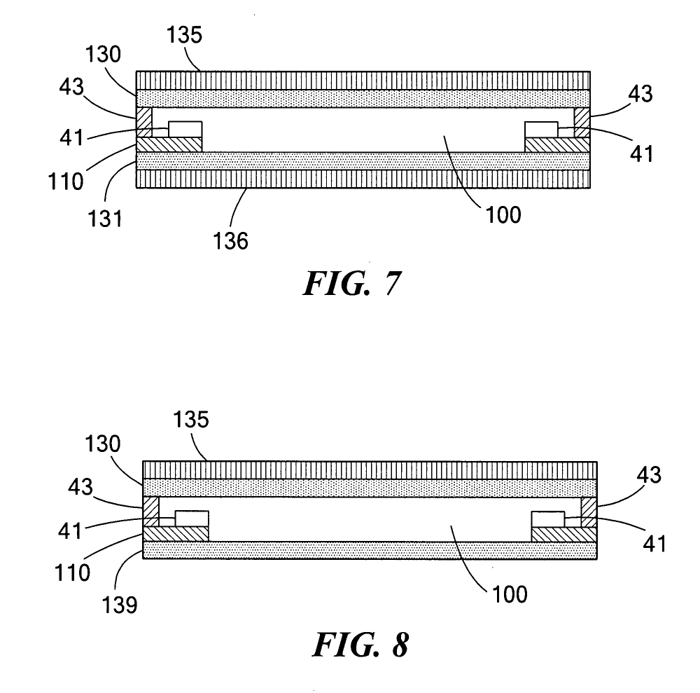

FIG. 7 shows a cross sectional view of a bi-facial backlight assembly in accordance with this invention, which has been built to illuminate a Kopin Corporation 640×480 Cyberdisplay. A printed circuit board 110 is prepared with the center area removed to create a rectangular aperture having a size approximately the same as or slightly larger than the 640×480 LCD pixel field. As will be shown, the volume removed from the printed circuit board to create this aperture will become part of the cavity that contains the optical material body 100. LEDs 41 are placed at the corners of the aperture, as shown above in FIG. 4. An optical diffusing plate 131 is used to form an optical back surface of the cavity that will contain the optical material. A spacer 43 having a height of 1.5 mm is added to the printed circuit board; this spacer forms the peripheral boundary of a mold. The cavity is filled with a mixture of optical cement and scattering bubbles. Good results have been obtained using 3M Glass Bubbles (K1) mixed in Norland UV-cured Optical Adhesive 61. A ratio of 10 cubic millimeters of glass bubbles in 2 milliliters of optical adhesive produces a uniform emitting area of the size of a 640×480 Cyberdisplay. A diffusing plate 130 is added and the Norland adhesive is cured with ultraviolet light which forms a solid integrated system. It may be seen that the LEDs 41 are encapsulated within the optical material in this example, which has the advantage of improved optical coupling between the LEDs and optical material, thereby deriving an improvement in efficiency. Although in this example the optical material body 100 was formed by casting, it is also possible to form the material separately by any number of methods and subsequently to bond the optical material to the printed circuit board.

Brightness enhancing films 135, 136, such as are available from 3M, are preferably added to the outer faces. Any number of such films may be added to improve the uniformity or directionality of the emitted light or to enhance the coupling of the light to the LCD.

Many of the backlight improvements of this invention may be applied in cases where only one LCD is used and only one aperture is required. An example is shown in FIG. 8 in which a reflective surface such as mirror 139 replaces the diffuser and brightness enhancing film on one surface. Such mirrors are capable of very high specular reflectance (exceeding 95%) and the combination of a mirror and the optical material acting as a solid diffusing medium increases the efficiency of the backlight as compared to conventional cavity designs. The mirror may be coated on its interior surface with thin films, brightness enhancing films or other optical layers to improve the overall efficiency of the backlight assembly.

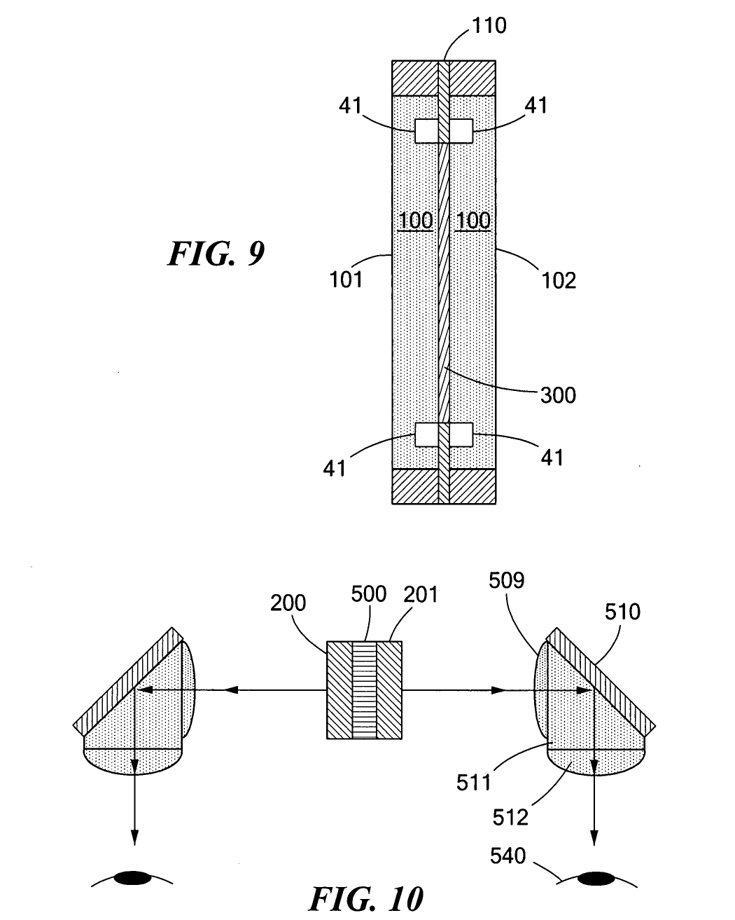

Many variations are possible without departing from the scope of this invention. For example, FIG. 9 illustrates that the LEDs 41 may be placed on both sides of the printed circuit board 110. Optical films 300 may be placed inside the optical material 100 in order to improve the angle of incidence of photons on the light emitting faces 101 and 102, or for other improvements in efficiency or uniformity of brightness and color. The optical films 300 may be placed at angles to the printed circuit board. The optical material 100 may have a minimal concentration of scattering sources or even no scattering sources.

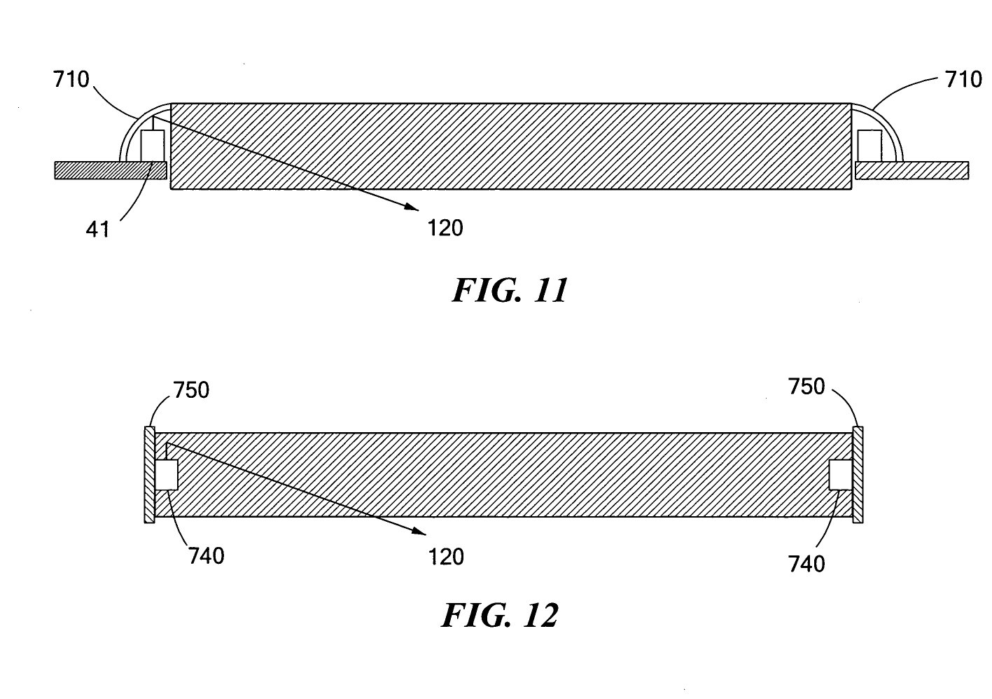

The LEDs may have significant radiation in a direction other than the nominal exit face of the LED. Thus top emitting LEDs may have significant light emission to the side and through the bottom, and side emitting LEDs may emit light from the top and through the back. These additional emissions may be captured by placing reflective surfaces 710 above or behind the LEDs as shown in FIG. 11, for example (but not limited to) using a reflective spacer to cast the backlight or incorporating reflective layers in the backlight cover plate.

An alternative to using side emitting LEDs is to use top emitting LEDs mounted in a transverse fashion as in FIG. 12 so as to couple light laterally into the optical material, or to use an angled reflective surface as in FIG. 11 to couple the light from top emitting LEDs into the optical material. This configuration might be used, for example, in cases in which side emitting LEDs are not available with the required wavelength distribution. The top emitting LEDs 740 may optionally be mounted on narrow printed circuit boards 750 or flex ribbons to facilitate coupling them to the backlight optical material.

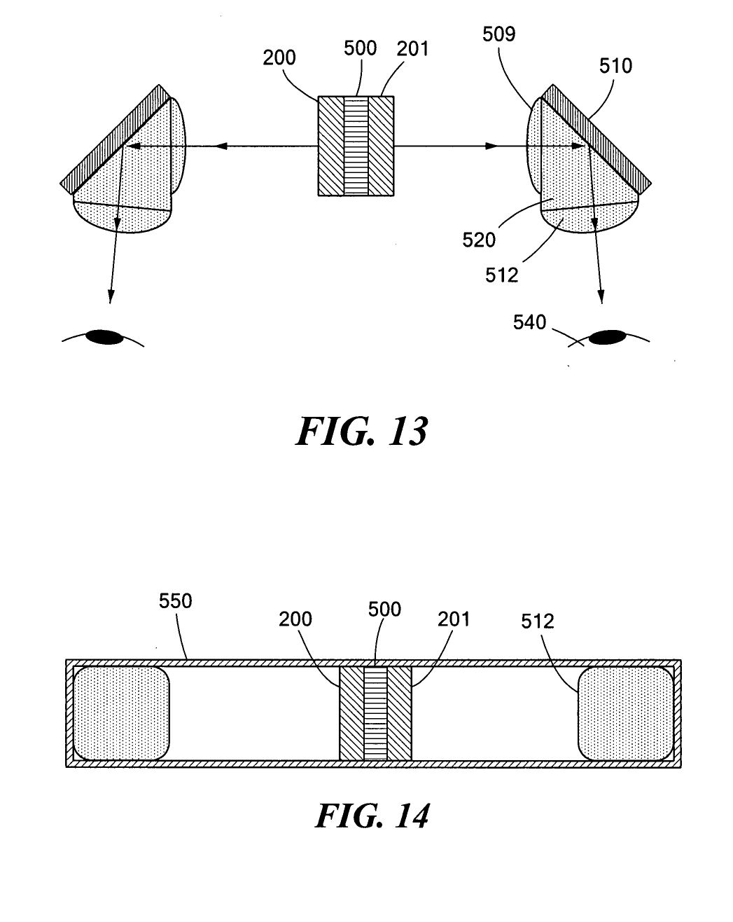

FIG. 10 illustrates one embodiment employing the backlight assembly in an eyewear-like binocular display or viewer. The backlight assembly 500 is joined to two LCDs 200 and 201 which are positioned so as to be in optical alignment with objective lenses 509. The objective lenses are affixed to optical pipes 511. The optical pipes employ mirrors 510 and eyelenses 512 to relay light to the eye 540 and also to magnify the image. FIG. 10 illustrates a system in which the eyes converge at infinity and in which the focal length is set to a large distance to approximate infinity. FIG. 13 shows that the convergence distance may be reduced from infinity to any closer distance by rotating the pipes by a small angle. Additionally, the focal lengths of the lenses 509 and 512 should be commensurately adjusted so that the convergence distance and the focal plane distance are approximately the same. As shown in FIG. 14, either of these systems may be installed in a frame or housing 550 which serves to hold the parts in optical alignment. The housing 550 may be made clear so that the user has a largely unobstructed view of the environment, or it may be made opaque to minimize intrusion of ambient light into the optical system, or it may be made with some sections clear or tinted and other sections opaque.

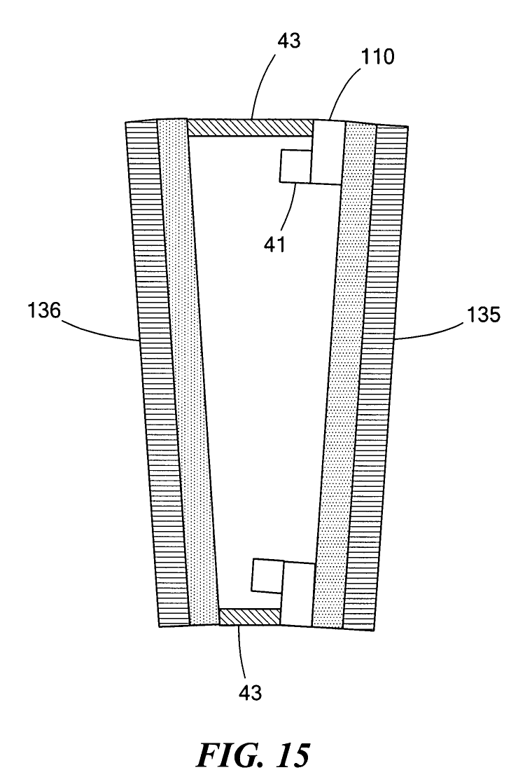

The backlight assembly may be designed to facilitate curvature of the enclosure that houses the binocular system. FIG. 15 shows a cross section of a backlight assembly in which the spacer 43 has been tapered so that the surfaces of the optical material body are not parallel. Many variations are possible in the design of the printed circuit board 110 and the location and number of the LEDs 41 to obtain uniformity of brightness across the surfaces. For example, as shown in FIG. 7, a spacer 43 and LEDs 41 may be placed on both sides of the printed circuit board so as to place the printed circuit board and LEDs approximately at the mid-point between the brightness enhancing films 135, 136. Many other variations are possible without departing from the scope of this invention.

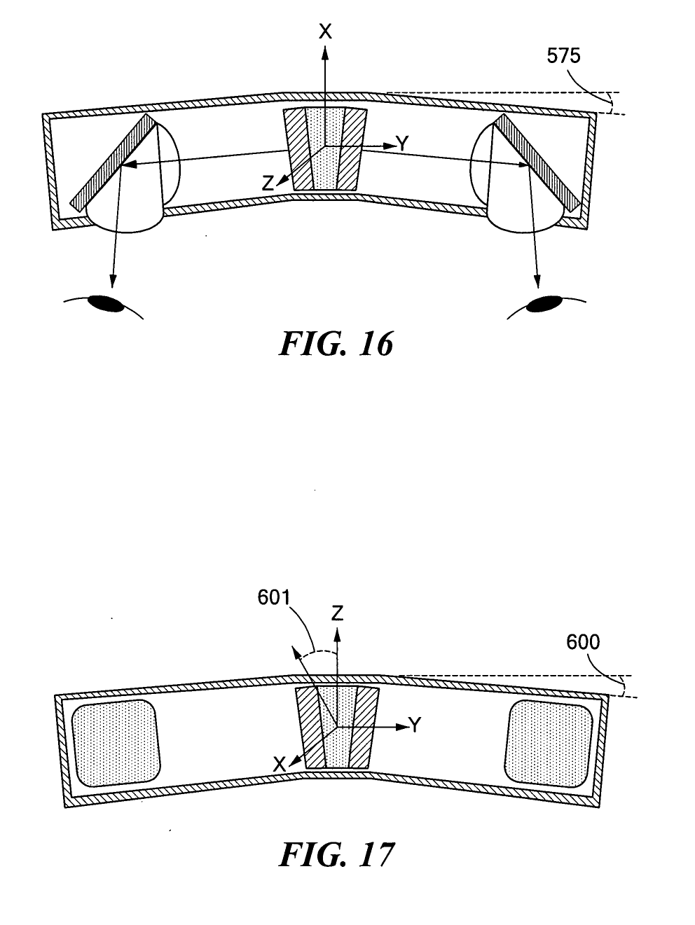

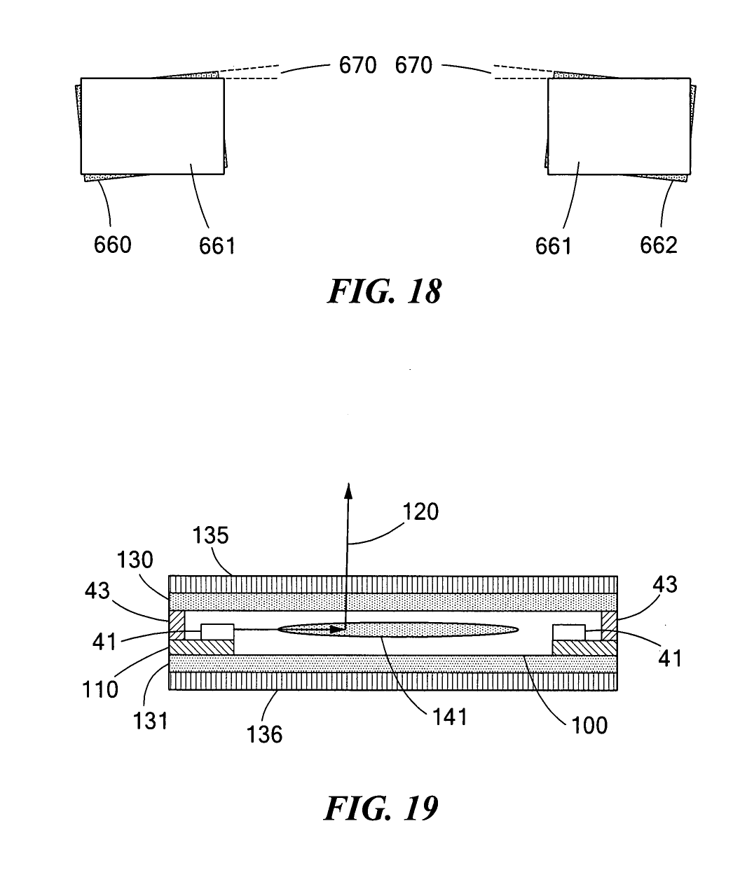

A backlight assembly having a taper employed for enhanced face curvature is shown in the front view in FIG. 17. In this figure and in FIG. 18, the z axis is the vertical axis, the x axis is in the direction of the user's gaze, and the y axis is parallel to the plane of the user's pupils. In FIG. 16, face curvature is created by tilting the optics with respect to the vertical (z) axis, meaning that the left and right optical axes are at an angle 575 with respect to the y axis. In such a case, the pipes and associated lenses are rotated about the z axis so that the user's eyes converge on a virtual image at the appropriate distance. Note that the pipe surfaces are biased so that the lenses are viewed at the correct angles.

A tapered backlight assembly can also be applied to curvature about the x axis. Such curvature would allow the backlight assembly and LCDs to be at a higher elevation than the eye lenses, as shown in FIG. 17. In this case, light propagating along the optical axis is at an angle 600 to the y axis. In such a way, the backlight assembly and LCDs may be placed above the nose, while the eye lenses are placed in front of the eyes. The correction for the rotation of the image is simple. Referring to FIG. 18, an uncorrected left image 660 and uncorrected right image 662 are rotated by an angle 670 which is equal to the angle 600 (in FIG. 17). Such rotated images cannot be converged by the average user. However, rotation of the backlight assembly and LCDs in the x-z plane by an angle 601 results in a rotation of both the left and right images. If the angle 601 is equal to angle 600, then the resultant left image 661 and right image 663 will be corrected for the presence of angle 600 and the user will be able to fuse the images.

The invention is not to be limited by what has been particularly shown and described, except as indicated by the appended claims.

What is claimed is:

1. A backlight assembly comprising:
a circuit substrate comprising a first surface defining a first side and a second surface defining a second side, an opening formed through the circuit substrate from the first side to the second side;
a body of optical material disposed within the opening in the circuit substrate, the body comprising an edge disposed within the opening in the circuit substrate, a first light emitting face located on the first side of the circuit substrate, and a second light emitting face located on the second side of the circuit substrate; and
a light source disposed to direct light into a location along the edge of the optical material body, the light source in communication with circuitry on the circuit substrate.

2. The assembly of claim 1, wherein the optical material is physically coupled to the light source.

3. The assembly of claim 1, wherein the optical material encapsulates the light source.

4. The assembly of claim 1, wherein the first and second light emitting faces are flat.

5. The assembly of claim 1, wherein the first and second light emitting faces are curved.

6. The assembly of claim 1, wherein the first and second light emitting faces are shaped to provide a desired light emission pattern.

7. The assembly of claim 1, wherein the first and second light emitting faces are textured.

8. The assembly of claim 1, wherein the light source comprises one or more light emitting diodes.

9. The assembly of claim 1, wherein the light source comprises a plurality of light emitting diodes disposed to direct light into a plurality of locations along the edge of the optical material body.

10. The assembly of claim 1, wherein the light source comprises a plurality of side-emitting light emitting diode packages.

11. The assembly of claim 1, wherein the light source comprises a plurality of top-emitting light emitting diode packages.

12. The assembly of claim 1, wherein the light source comprises a plurality of unpackaged light emitting diodes.

13. The assembly of claim 1, further comprising a reflective surface adjacent the light source to direct emissions toward the optical material body.

14. The assembly of claim 1, wherein the optical material body further comprises corner regions, and the light source comprises a light emitting diode located generally at each corner region of the optical material body.

15. The assembly of claim 1, wherein the optical material body further comprises a generally rectangular shape having four sides, and the light source comprises a light emitting diode located generally along each of the four sides.

16. The assembly of claim 1, wherein the light source comprises a plurality of light emitting diodes located on one of the first and second sides of the circuit substrate.

17. The assembly of claim 1, wherein the light source comprises a plurality of light emitting diodes located on both of the first and second sides of the circuit substrate.

18. The assembly of claim 1, wherein the optical material is comprised of optical polymethylmethacrylate, polycarbonate, glass, urethane, or optical epoxy.

19. The assembly of claim 1, wherein the optical material has an index of refraction between 1.4 and 1.8.

20. The assembly of claim 1, wherein the optical material has a low optical absorption.

21. The assembly of claim 1, wherein the circuit substrate comprises a printed circuit board.

22. The assembly of claim 1, wherein the circuit substrate comprises a flexible printed circuit.

23. The assembly of claim 1, wherein the optical material extends to edges of the circuit substrate.

24. The assembly of claim 1, further comprising a diffusing sheet disposed on at least one of the first and second light emitting faces of the optical material body.

25. The assembly of claim 1, further comprising a brightness enhancing film disposed on at least one of the first and second light emitting faces.

26. The assembly of claim 1, further comprising laminar reflectors disposed within the optical material body.

27. The assembly of claim 26, wherein the laminar reflectors comprise a stack of optically clear plates interspersed with partially reflective dielectric coatings.

28. The assembly of claim 26, wherein the laminar reflectors comprise plates having textured surfaces.

29. The assembly of claim 26, wherein the laminar reflectors comprise plates separated by air gaps.

30. The assembly of claim 26, wherein the laminar reflectors comprise plates separated by plates or films of a different index of refraction.

31. The assembly of claim 1, further comprising scattering centers distributed within the optical material.

32. The assembly of claim 31, wherein the scattering centers comprise air-filled glass bubbles.

33. The assembly of claim 31, wherein the scattering centers comprise gas bubbles.

34. The assembly of claim 31, wherein the scattering centers comprise particles having a different index of refraction than the optical material.

35. The assembly of claim 31, wherein the scattering centers comprise white or metallic particles.

36. The assembly of claim 1, further comprising reflecting or refracting elements distributed within the optical material.

37. The assembly of claim 1, further comprising light emitting phosphors dispersed throughout the optical material.

38. The assembly of claim 1, further comprising light emitting phosphors coated on one or both of the first and second light emitting faces of the optical material.

39. The assembly of claim 1, further comprising an optical film disposed within the optical material.

40. The assembly of claim 1, further comprising a shaped diffusing element disposed with the optical material.

41. The assembly of claim 1, further comprising a shaped reflective element disposed with the optical material.

42. The assembly of claim 1, further comprising a reflective surface disposed on one or both of the first and second light emitting faces.

43. A backlight and display assembly comprising:
a backlight assembly according to claim 1;
a first display disposed on the first side of the circuit substrate to receive light emitted from the first light emitting face of the optical material body; and
a second display disposed on the second side of the circuit substrate to receive light emitted from the second light emitting face of the optical material body.

44. The assembly of claim 43, wherein the first display and the second display comprise liquid crystal displays.

45. The assembly of claim 43, wherein the first light emitting face has an area corresponding to an area of a pixel field of the first display, and the second light emitting face has an area corresponding to an area of a pixel field of the second display.

46. The assembly of claim 43, further comprising a spacer between the circuit substrate and at least one of the first and second displays, the optical material body filling a volume between the spacer and the first and second displays.

47. The assembly of claim 46, wherein the spacer masks areas outside an active matrix pixel area on the first display or the second display.

48. The assembly of claim 43, further comprising a mask disposed to mask areas outside an active matrix pixel area on the first display or the second display.

49. A binocular viewing device comprising:
a backlight assembly according to claim 1;
a first display disposed on the first side of the circuit substrate to receive light emitted from the first light emitting face of the optical material body; and
a second display disposed on the second side of the circuit substrate to receive light emitted from the second light emitting face of the optical material body;
a first optical assembly disposed to receive an image from the first display and relay the image to a user's first eye;
a second optical assembly disposed to receive an image from the second display and relay an image to a user's second eye; and
a frame or housing, the backlight assembly, the first display, and the second display supported by the frame or housing between the first optical assembly and the second optical assembly.

50. The binocular viewing device of claim 49, wherein a focal length and an image convergence distance are infinity or approximately infinity.

51. The binocular viewing device of claim 49, wherein a focal length and an image convergence distance are less than infinity.

52. The binocular viewing device of claim 49, wherein the optical material body is tapered so that the first light emitting face and the second light emitting face of the backlight assembly are not parallel.

53. The binocular viewing device of claim 52, wherein the taper imparts a curvature about a horizontal axis to the binocular viewer.

54. The binocular viewing device of claim 52, wherein the taper imparts a curvature about a vertical axis to the binocular viewer.

55. The binocular viewing device of claim 49, wherein the first optical assembly and the second optical assembly each comprise an objective lens in optical alignment with an associated one of the first display and the second display.

56. The binocular viewing device of claim 55, wherein the first optical assembly and the second optical assembly each further comprise a reflective surface to reflect an image from the objective lens to the user's eyes.

57. The binocular viewing device of claim 49, wherein the first optical assembly and the second optical assembly further comprise an optical component to magnify an image.

58. The binocular viewing device of claim 49, wherein the frame or housing is head-mountable for wearing by the user.

59. The binocular viewing device of claim 58, wherein the frame or housing holds the backlight assembly, the first display, the second display, the first optical assembly, and the second optical assembly in optical alignment.

60. The binocular viewing device of claim 49, wherein the backlight assembly, the first display, and the second display are disposed generally midway between the first optical assembly and the second optical assembly.
